(19) United States
(12) Patent Application Publication
(10) Pub. No.: US 2022/0143429 A1
(43) Pub. Date: May 12, 2022

(54) Face Shield Assembly with Positive Pressure Airflow

(71) Applicant: Pengsuorn Thomas Chea, Fontana, CA (US)

(72) Inventor: Pengsuorn Thomas Chea, Fontana, CA (US)

(21) Appl. No.: 17/484,797

(22) Filed: Sep. 24, 2021

Related U.S. Application Data
(60) Provisional application No. 63/198,764, filed on Nov. 11, 2020.

(51) Int. Cl. A62B 7/12; A41D 13/11; A62B 18/08; A62B 18/00; A62B 7/10; A62B 9/00

(52) U.S. Cl. CPC A62B 7/12; A41D 13/1161; A41D 13/1184; A62B 9/00; A62B 18/006; A62B 7/10; A62B 18/084

(57) ABSTRACT

A face shield assembly with positive pressure airflow comprises a head band, a transparent face shield, a foam spacer, and at least one airflow supply unit providing a positive pressure airflow. The head band attaches the face shield outward and the foam spacer inward. The airflow supply unit has hose(s) to connect the holes distributed in the foam spacer, consequently bring forth airflow on the front of the user's face to prevent the droplets and particles from being inhaled into the user's nose and mouth.

### CROSS-REFERENCE TO RELATED APPLICATIONS

This non-provisional application claims priority under 35 U.S.C. § 119(a) on U.S. Provisional Patent Application No(s). 63/198,764 filed on Nov. 11, 2020, the entire contents of which are hereby incorporated by reference.

### Field of the Invention

The present invention relates generally to a face shield and more particularly, to a face shield assembly with positive pressure airflow.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A face shield may be used to help reduce the spread of contagious diseases such as COVID-19, cold, and flu by preventing virus-laden droplets from reaching entry points on the face. However, there is no positive airflow in a typical face shield to provide cool clean air, protection from debris particles in the air, and fog reduction.

Existing devices that protect the face and provide positive airflow are too bulky and expensive to carry around. The devices take too long to set up for proper fit and functionality and they take longer to clean after contamination than a face shield.

As can be seen, there is a need for a small, comfortable, portable head unit that shields the user's face and provides positive air pressure so harmful agents are deflected from the face.

The inventive shield is easy to carry around for everyday use in a hospital environment. The invention is cheap, comfortable, reusable, disposable, and easy to put on or take off.

A person may use the invention while interacting with other people within 6 feet to help protect the user from direct exposure to diseases present in respiratory droplets and to protect a user's eyes from dangerous projectiles. The inventive face shield may be ideal for use in dentistry or Emergency Department (ED) trauma.

### SUMMARY OF THE INVENTION

Broadly, an embodiment of the present invention provides a transparent face shield, a head band, a foam spacer, and at least one airflow supply unit. Airflow is directed downward toward the face and reduces fog on the face shield. The face shield with positive air pressure provides the user with superior protection from airborne droplets.

The face shield may be detachable from the head band for easy cleaning or disposal. In some embodiments, the invention further comprises a plastic shield protective cover.

The system and method of operation of the embodiments disclosed herein, however, together with additional objectives and advantages thereof, will be best understood from the following description of specific, exemplary embodiments when read in connection with the accompanying drawings.

### BRIEF DESCRIPTION OF THE DRAWINGS

The invention will now be described, by way of example, with reference to the accompanying drawings, in which:

FIG. 1 is a perspective photographic view of a face shield assembly with positive pressure airflow, in accordance with an embodiment of the present invention.

FIG. 2. is a front elevation view of a face shield and head band of a positive air pressure face shield assembly, in according to an embodiment of the invention;

FIG. 3 is a rear elevation view of FIG. 2, in according to an embodiment of the invention;

FIG. 4 is a top photographic view of a head band of the face shield assembly, in according to an embodiment of the invention;

FIG. 5 is a perspective photographic view of another face shield assembly with positive pressure airflow, in accordance with an embodiment of the present invention.

FIG. 6 is a perspective photographic view of a face shield assembly with two airflow supply units, in accordance with an embodiment of the present invention.

FIG. 7 is a perspective photographic view of another face shield assembly with two airflow supply units, in accordance with an embodiment of the present invention.

FIG. 8 is a perspective photographic view of another face shield assembly with a rigid cap, in accordance with an embodiment of the present invention.

FIG. 9 is a perspective photographic view of a face shield assembly with a soft cap, in accordance with an embodiment of the present invention.

FIG. 10 is a perspective photographic view of a face shield assembly with a polymeric film, in accordance with an embodiment of the present invention.

FIG. 11 is a perspective photographic view of a face shield assembly with a clip, in accordance with an embodiment of the present invention.

Like reference numerals refer to like parts throughout the various views of the drawings.

### DETAILED DESCRIPTION OF THE INVENTION

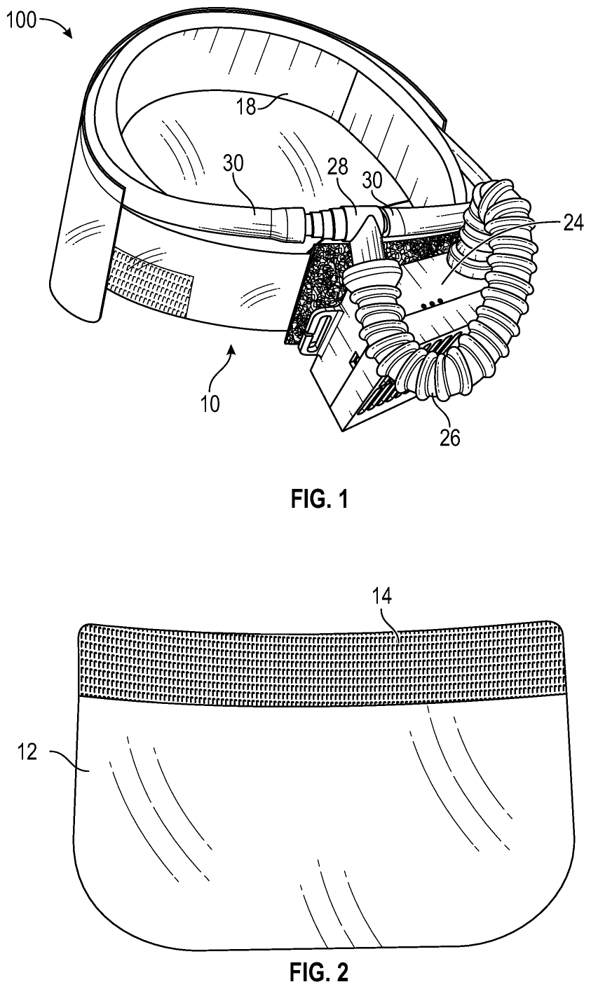

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing FIG., as may be further described or explained by the entire written specification of which this detailed description is an integral part. The drawings are intended to be read together with the specification and are to be construed as a portion of the entire “written description” of this invention as required by 35 U.S.C. § 112.

Broadly, each of those embodiments below of the present invention provides a positive pressure airflow to the space between the face shield and the user's face, having a transparent face shield, a head band, a foam spacer, and at least one airflow supply unit. Airflow is directed downward toward the face closely, preferably on the front space of the face, and reduces fog on the face shield. The face shield with positive air pressure provides the user with superior protection from airborne droplets.

The face shield may be detachable from the head band for easy cleaning or disposal. In some embodiments, the invention further comprises a plastic shield protective cover.

In some embodiments, the head band may have loop material on both surfaces so that hook material may attach to the head band at any location, providing an attachment feature for the remaining components of the invention. The head band may be easily adjusted with two hook and loop attachment locations for proper fitting.

The foam spacer acts as a barrier against entry of particles.

The airflow supply unit(s) may provide positive air pressure by delivering fresh air to the space between the face shield and the user's face. One embodiment may provide airflow without a hole in the foam. Alternatively, the foam spacer may have holes to accommodate airflow. A plurality of air tubes may be routed through the foam spacer to deliver fresh air to multiple positions around the face. Preferably, the air tubes have a smooth surface for easy cleaning. The airflow supply units may be attached anywhere on the head band. Preferably, the airflow supply units have adjustable airspeed (or flow rate) and a long battery life. Airflow supply units may be obtained from a. vendor such as Shenzhen Aurora Technology Limited of China or Broad USA.

In some embodiments, the face shield has one airflow supply unit with three-way adaptor air hoses.

In some embodiments, the face shield has two airflow supply units with dedicated air hoses positioned along the head band.

In some embodiments, a replaceable filter may be added to the airflow supply unit to supply clean air into the air tubes. For example, the filter may be a carbon filter or a non-woven membrane filter. The filters may be sized for easy cleaning and to protect the internal main filter. The added filters seal the space gap between the plastic and sheet behind the air unit and are easy to remove for daily usage. Hook and loop closure at the back of the filter unit allows for easy adjustment.

In some embodiments, a rechargeable USB battery power blank unit may be attached to the airflow supply unit to prolong fan usage. Preferably, the airflow supply unit may be charged by way of a USB connector.

In some embodiments, the invention comprises an open-air unit. In some embodiments, the face shield is a one-piece encapsulated shield.

In some embodiments, the invention further comprises a flexible cap, such as a shower cap, or a hard cap to the top of the face shield to help prevent the user's exposure to droplets. In some cases, the invention further comprises another flexible protective device, such as a shower cap, at the bottom of the user's face, covering the lower portion of the shield and looping around both ears.

In some embodiments, an easy-to-clean hard plastic cover or cap attachment may be provided over the head so that the user does not have to clean the foam and hook and loop material. Preferably, the shield and cap system may comprise two airflow units. Preferably, the cap is attached with an easy on-and-off hook-and-loop system.

In some embodiments, the user may add their favorite sport logo teams or customize the face shield with a name on the head band.

The materials of construction are not particularly limited. The face shield may be made of any suitable transparent polymer sheet, such as polycarbonate and poly-cyclohexylenedimethylene terephthalate glycol (PCTG). For example, suitable polycarbonate face shields may be obtained from 3M™ and from Lincoln Electric™. The head band may be a soft velour loop, such that hook material may be attached. For example, a suitable head band may be obtained from a Chinese vendor, Zhongshan Liyao Weaving Co., Ltd. The head band may have a hook and loop closure, such as 3M® adhesive hook and loop tape. The foam spacer may be any suitable foamed polymer and may be obtained from a vendor, such as Changzhou Yiteng, Rubber and Plastic Products Co., Ltd. In some embodiments, the foam may be dipped in marine vinyl coating for easy cleaning.

Each component may have any dimensions suitable for the user. For example, the head band may be about 1.5″×about 30″. The head band may be manufactured from an about 5′ strip of adhesive loop material folded in half. The filters may be about 2.25″ by about 2.2″. The foam may be about 1¾″ to about 2″ thick at the thickest portion, about 8″ wide, and about 7¾″ to about 8″ deep, with about two approximately ⅝″(16 mm) holes set about 3″ apart at the front of the head for airports. The cap may overlap the face shield by about 2″. The shield may be about 11.75″×about 7.87″×about 0.02″. In some cases, the shield may be about 0.08″ thick, such as an exemplary shield produced by Shenzhen RJC Industrial Co., Ltd. The hook material (of a hook-and-loop attachment) may be about 2″×about 11.75″ across the shield and about 2″×about 2″ strips attached to the foam on each side of the head and to the back of each airflow supply unit. The strips on each side of the head may be folded in half so that both surfaces have hook material attachable to loop material.

Referring now to FIG. 1 through 10, several embodiments of face shield assemblies according to the invention are shown, as well as components thereof.

FIG. 1 illustrates an embodiment of the present invention. In this embodiment, a positive pressure airflow face shield assembly 100 comprises a face shield 12, a head band 16, a foam spacer 18, and an airflow supply unit 24.

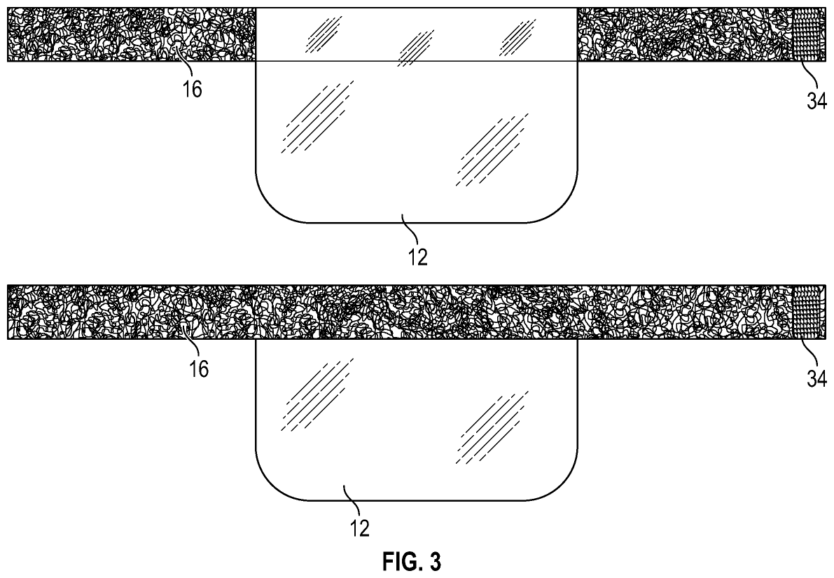

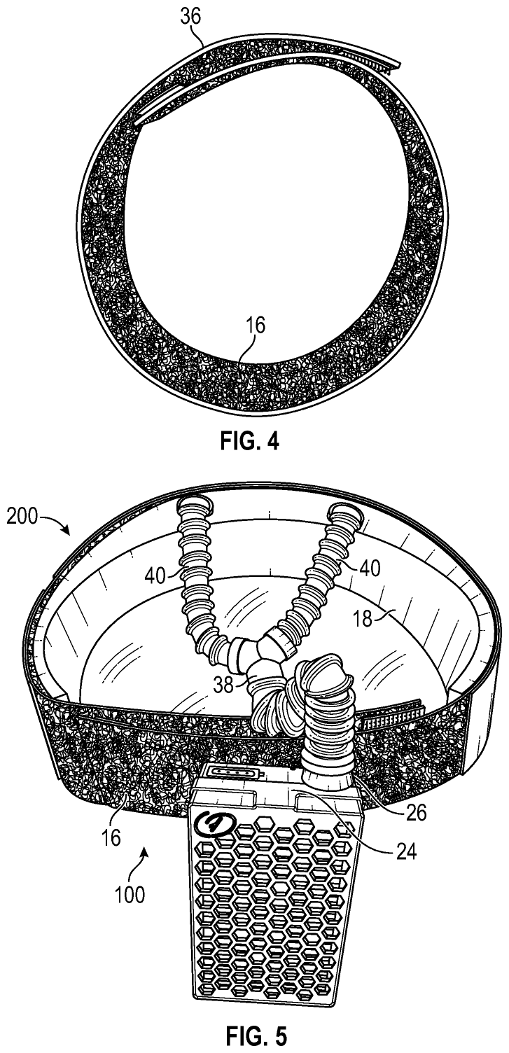

In one example, the face shield 12 is transparent and attaches to the head band 16. The head band 16 is shown with an attachment strip 34 at each end configured to close the head band 16 around the user's head, as illustrated in FIG. 2. As FIG. 3 shows, a hook strip 14 is mounted on top of the face shield 12 for attachment to the head band 16, detachably. As mentioned before, the attachment in those embodiments may be selected from hook and loop, which is attached or detached in a flexible way. Alternatively, the head band 16 with a pair of attachment strips 36 for adjusting fit of the inventive assembly, as shown in FIG. 4.

Preferably, the head band attaches the face shield outward and the foam spacer inward.

In one example, the foam spacer 18 is shaped to be adjusted to be attached to the head band 16 therein, and to be accommodated to comfortably contact with the user's forehead in wearing the shield. Preferably, the foam spacer may be attached to the head band 16, via a hook and loop.

In one example, the airflow supply unit 24 provides a positive pressure airflow to the space between the face shield and the user's face. Preferably, the airflow supply unit 24 delivers air to each side of the foam spacer 18 by way of hoses 26, 30 and splitter 28. The hose 26 is connected to the air outlet of the airflow supply unit 24, and the hoses 30 are two separate hoses toward opposite directions (three-ways tube). Specifically, the splitter 28 is well-positioned between the hose 26 and the two separate hoses 30 to connect thereof. Therefore, via the connection discussion above, the airflow supply unit 24 delivers air to the two separate hoses 30, whose outlets may be direct to where the user would like to place. In this example, preferably, the separate hoses 30 extends to the inner space between the foam spacer 18 between the head band 16.

Preferably, inside the airflow supply unit 24, there are more than one filter media therein. Optionally, those filter media may be shaped into layers, preferably being configured to stack in an overlap, applying to prevent the droplets or particles from being delivered to the hoses of the present shield assembly. Preferably, the airflow supply unit 24 has a power regulation processor built in the unit to regulate the power, and then to adjust the airflow rate. Preferably, the airflow supply unit 24 may be recharged by USB cord or portable power.

FIG. 5 shows another preferable embodiment of the present invention. In this preferable embodiment, a positive pressure airflow face shield assembly 200 comprises a face shield 12, a head band 16, a foam spacer 18, and airflow supply unit 24 attached to a head band 16. Air is supplied through two holes in the foam spacer 18 through hoses 26, 40, and splitter 38.

In one example, the two holes are well centro-symmetrically distributed in the center of the foam spacer 18. In an implementing way when the airflow supply unit 24 is actuated, the airflow with positive pressure that is delivered from the two holes will be ejected from up to down in the inner space of the shield assembly 200. The continuous downward airflow brings a positive pressure on the front of the user's face to prevent the droplets and particles from being inhaled into the user's mouth and nose.

Also, one of the objectives of the present invention is to reduce the fog on the shield, which may be caused by the exhaling from the user. A positive pressure downward on the front of the face blows away most of the user's exhalation, and then prevents the creation of fog on the shield.

Typically, the two holes are shaped to be through the foam spacer 18 from the top to bottom surfaces, perpendicularly. Therefore, the releasing airflow from the two holes will blow to the maximum space around the user's face, and particularly, would not produce an encountering between the two separate airflows. Meanwhile, in order to enhance the prevention of droplets and particles from entering to the shield assembly, the two holes are distributed at an optimized distance. An ideal distance would apply the positive pressure airflow to blow away the particles or droplets gathering around the nose or mouth. For example, the distance between the two holes is preferably from 1.96″ to 3.92″, more preferably from 1.96″ to 2.75″ cm.

Preferably, to facilitate the airflow and increase the blowing area thereof, the flow rate of the air created by the airflow supply unit 24 is optimized. Too fast or too slow airflow rate has caused an inferior quality of preventing droplets and particles. Preferably, the rate of airflow from the two holes is adjusted to between 400 to 500 CFM (Cubic Feet Per Minute), preferably 430 to 470 CFM and 440 to 450 CFM, by controlling the power of the airflow supply unit 24, consequently rendering an appropriate prevention to droplets and particle from being inhaled and prevention to the user's exhalation from arriving on the shield. An overfast airflow, for instance with a rate of more than 500 CFM, causes less blowing area, and discomfort to the user's face. An overslow airflow, for instance with a rate of less than 400 CFM, causes less momentum when air is flowing out from the holes, consequently ensuring the droplets or particles around the nose and mouth being blown away. Thus, an appropriate control values of airflow rate allows the shield assembly to prevent virus-laden droplets from reaching entry points on the face.

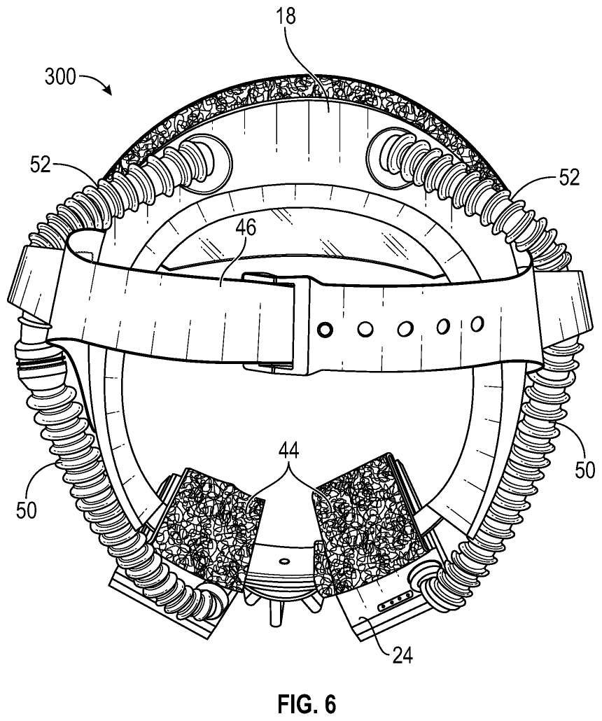

FIG. 6 show yet another face shield assembly 300 of the present invention, having two airflow supply units 24, and each having a dedicated hose 50, rather than a foam spacer, a head band. As FIG. 6 shows, a face shield assembly 300 having two airflow supply units 24 attached to the assembly 300 with a dedicated tube 50 respectively. In addition, the assembly 300 has a few straps 44. The Hoses 50 attach to another hose 52 that attaches to the holes in the foam spacer 18. A buckled strap 46 is provided for support.

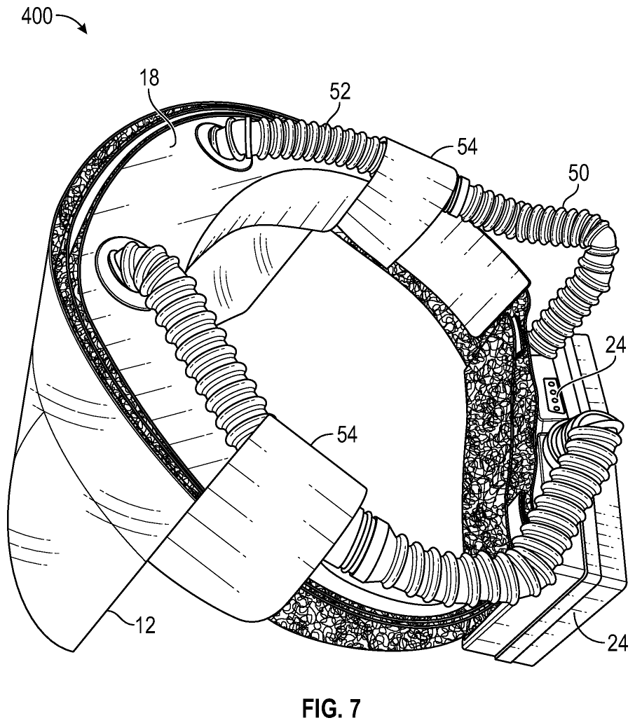

An alternative embodiment of the present invention provides yet another face shield assembly 400, as shown in FIG. 7. In this embodiment, the hoses 50, 52 are strapped to the assembly 400 with straps 54. The straps 54 are used to secure and support the connection between the hoses 50 and the hoses 52.

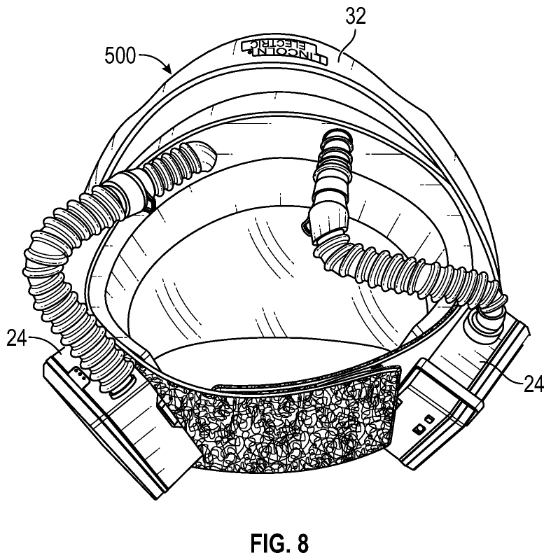

FIG. 8 illustrates another face shield assembly 500 having a rigid cap 32 attached over the face shield 12, the head band 16 and foam spacer 18. The cap 32 may be designed or decorated to some different shape to cover the top of the user's head for support and protection.

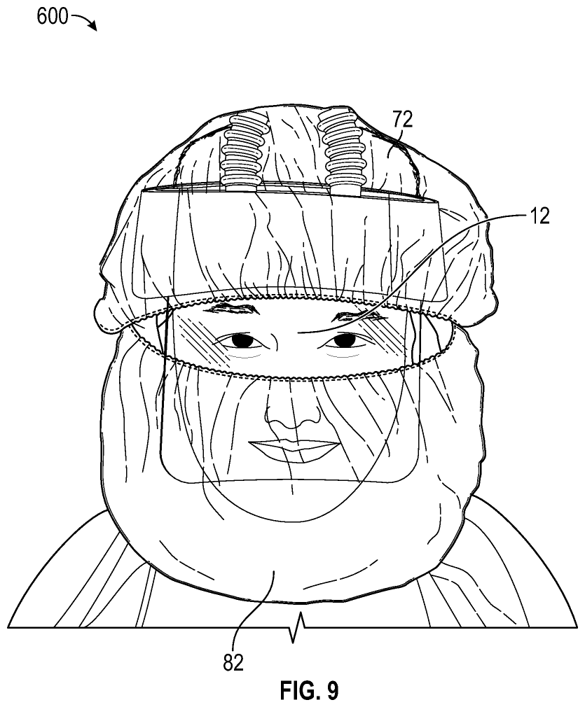

FIG. 9 illustrates another face shield assembly 600 having a soft or flexible cap 72 and mask 82 which reduce the user's exposure to airborne particulates and droplets. Preferably, the soft or flexible cap and mask can be pulled to cover the whole assembly, except for the eyes portion.

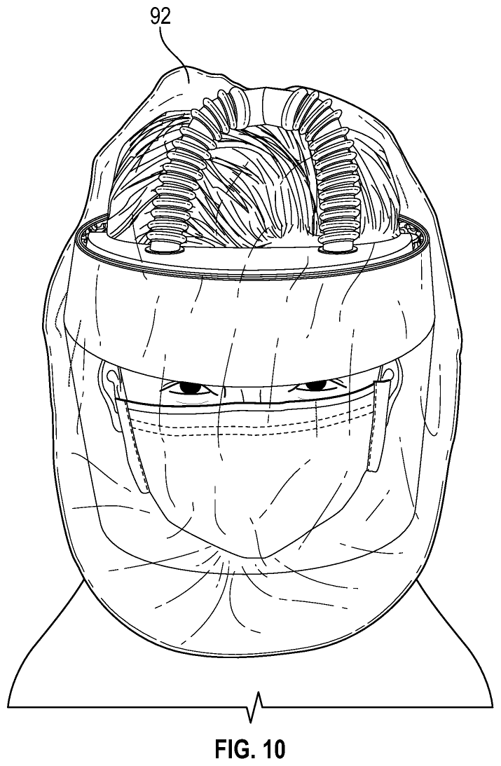

FIG. 10 shows another face shield assembly of the present invention, having a polymeric film 92 wrapping around the face shield assembly.

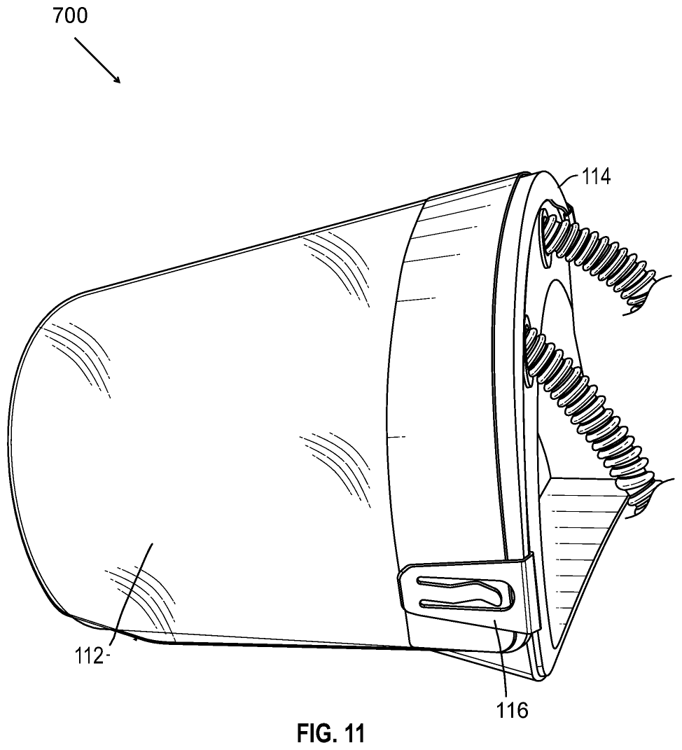

FIG. 11 shows another face shield assembly of the present invention. In this alternative embodiment, the face shield assembly 700 has at least a clip 116 mounted on the face shield 114, Yes. In addition, a outer thin plastic film 114 is inserted into the clip 116 anytime.

One of the objectives of this embodiment is to provide safety and cleanness to dentists. In dentistry, the outer thin plastic film 114 is the primary protection from splashing, i.e., splattered bloods and bones debris. The outer piece is easily removable and replaceable with another new outer thin plastic film 114. Thus the face shield assembly 700 saves the dentists from cleaning the face shield itself.

Preferably, the face shield assembly 700 has two clips thereon. The outer thin plastic film 114 is made from PET, preferably with a thickness of 0.25 mm.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A face shield assembly with positive pressure airflow, comprising:
a head band, having an attachment strip at each end to close the head band around the user's head,
a transparent face shield, covering a user's face,
a foam spacer, being shaped to contact with the user's forehead, and
at least one airflow supply unit, providing a positive pressure airflow to the space between the face shield and the user's face,
wherein the head band attaches the face shield outward and the foam spacer inward, and the airflow supply unit delivers air to two holes distributed in the foam spacer by way of hoses and a splitter.

2. The face shield assembly of claim 1, wherein a hook strip is mounted on top of the face shield for attachment to the head band.

3. The face shield assembly of claim 1, wherein the airflow supply unit delivers air to each side of the foam spacer by way of hoses and a splitter.

4. The face shield assembly of claim 1, wherein the air flows continuously downward from the holes.

5. The face shield assembly of claim 1, wherein the airflow supply unit has more than one filter media therein.

6. The face shield assembly of claim 1, wherein the airflow supply unit has a built-in power regulation processor to regulate the power and adjust the airflow rate.

7. The face shield assembly of claim 1, wherein the airflow supply unit is recharged by a USB cord or portable power.

8. The face shield assembly of claim 4, wherein the two holes are centro-symmetrically distributed in the center of the foam spacer, and the distance between the two holes is preferably from 1.96″ to 3.92″.

9. The face shield assembly of claim 4, wherein the rate of airflow from the two holes is adjusted to between 400 to 500 CFM.

10. The face shield assembly of claim 1, wherein there are two airflow supply units and each having a dedicated hose separately.

11. The face shield assembly of claim 1, wherein the assembly further has a rigid cap attached over the face shield, head band, and foam spacer.

12. The face shield assembly of claim 1, wherein the assembly further has a soft or flexible cap and mask to cover the assembly.

13. The face shield assembly of claim 1, wherein the assembly further has a polymeric film wrapping around the face shield assembly.

14. The face shield assembly of claim 1, wherein the assembly further has at least a clip mounted on the face shield for inserting an outer thin film.
